(19) United States
(12) Patent Application Publication
(10) Pub. No.: US 2014/0114930 A1
(43) Pub. Date: Apr. 24, 2014

(54) RELIABILITY CALCULATION APPARATUS, RELIABILITY CALCULATION METHOD, AND COMPUTER-READABLE RECORDING MEDIUM

(71) Applicants: Yusuke Muraoka, Tokyo (JP); Dai Kusui, Tokyo (JP); Hironori Mizuguchi, Tokyo (JP); Yukitaka Kusumura, Tokyo (JP)

(72) Inventors: Yusuke Muraoka, Tokyo (JP); Dai Kusui, Tokyo (JP); Hironori Mizuguchi, Tokyo (JP); Yukitaka Kusumura, Tokyo (JP)

(73) Assignee: NEC CORPORATION, Tokyo (JP)

(21) Appl. No.: 14/127,592

(22) PCT Filed: Dec. 19, 2012
(86) PCT No.: PCT/JP2012/082866

§ 371 Date: Dec. 19, 2013

(30) Foreign Application Priority Data
Jan. 12, 2012 (JP) 2012-004399

(51) Int. Cl. G06F 17/30

(52) U.S. Cl. CPC G06F 17/30011
USPC 707/687

(57) ABSTRACT

In order to calculate a reliability that serves as an index of reliableness of an evaluator who evaluated a document, a reliability calculation apparatus (2) is provided with a reliability calculation unit (21) that specifies an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculates the reliability of each evaluator, based on the specified evaluation with respect to each author.

### TECHNICAL FIELD

The present invention relates to a reliability calculation apparatus and a reliability calculation method that are used in order to evaluate the reliableness of evaluation performed by a user, and a computer-readable recording medium storing a program for realizing the apparatus and method.

### BACKGROUND ART

In a search system, the ranking of documents is important in order to find a target document faster. Ranking is thus conventionally carried out in a search system so that documents that are evaluated by a large number of evaluators are ranked high.

Usually, it is easy for a searcher to evaluate whether or not a document should be ranked high with respect to individual search results. Therefore, in a conventional search system, an evaluator whose evaluations closely match other evaluators is regarded as a highly reliable evaluator, and search processing is executed so that a document that is evaluated highly by the highly reliable evaluator is ranked high in search results. This enables a document that is evaluated by a large number of evaluators to be ranked high in search results.

For example, Patent Document 1 discloses a specific example of such a conventional search system. Also, with the search system disclosed in Patent Document 1, an information evaluation apparatus is used, in order to specify documents evaluated highly by highly reliable evaluators. Here, an information evaluation apparatus used with the conventional search system will be described using FIG. 6.

FIG. 6 is a diagram showing an example of a conventional information evaluation apparatus. As shown in FIG. 6, an information evaluation apparatus 50 is provided with a document-evaluator storage unit 51, a matrix generation means 52, and an eigenvector generation means 53. The document-evaluator storage unit 51 stores associations between each of documents, evaluators of the documents and evaluation values of the documents.

The matrix generation means 52 generates two matrices, based on the stored associations. One is a matrix in which rows indicate evaluators, columns indicate documents, and elements represent the relationship between evaluators and documents. The other is a matrix in which rows indicate evaluators, columns indicate documents, and elements represent evaluation values. The matrix generation means 52 then creates a new matrix (score transition matrix) based on the relationship between the two matrices.

The eigenvector generation means 53 computes eigenvectors of the generated score transition matrix, uses the eigenvectors to further compute, for each document, a document score indicating the number of times that the document has been evaluated by an evaluator (evaluation frequency), and outputs the calculated document score. The document score indicates that a document has been highly evaluated by highly reliable evaluators, the higher the value of the score.

### DISCLOSURE OF THE INVENTION

### Problem to be Solved by the Invention

Incidentally, in the case where there is a limited amount of acquired data (evaluation data) on evaluation values relative to the number of documents, many documents will have been evaluated no more than once. This means that, with the text evaluation apparatus 50 disclosed in Patent Document 1, documents that are highly evaluated by highly reliable evaluators cannot be specified, since the reliability of the evaluators cannot be correctly evaluated in such a case.

The present invention has been made to solve the above problems and has as an object to provide a reliability calculation apparatus, a reliability calculation method and a computer-readable recording medium that enable the reliability of an evaluator to be calculated correctly even if there is a limited amount of evaluation data.

### Means for Solving the Problem

In order to attain the above object, a reliability calculation apparatus according to one aspect of the present invention is an apparatus for calculating a reliability that serves as an index of reliableness of an evaluator who evaluated a document, and including a reliability calculation unit that specifies an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculates the reliability of each evaluator, based on the specified evaluation with respect to each author.

Also, in order to attain the above object, a reliability calculation method according to one aspect of the present invention is a method for calculating a reliability that serves as an index of reliableness of an evaluator who evaluated a document, and including the step of (a) specifying an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculating the reliability of each evaluator, based on the specified evaluation with respect to each author.

Furthermore, in order to attain the above object, a recording medium according to one aspect of the present invention is a computer-readable recording medium storing a program for calculating by computer a reliability that serves as an index of reliableness of an evaluator who evaluated a document, the program including a command for causing the computer to execute the step of (a) specifying an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculating the reliability of each evaluator, based on the specified evaluation with respect to each author.

### Effects of the Invention

As described above, according to the present invention, the reliability of an evaluator can be correctly calculated even if there is a limited amount of evaluation data.

### BRIEF DESCRIPTION OF DRAWINGS

FIG. 1 is a block diagram showing a configuration of a reliability calculation apparatus according to an embodiment of the present invention.

FIG. 2 is a flowchart showing operations of a reliability calculation apparatus according to an embodiment of the present invention.

FIG. 3 is a block diagram showing an example of a computer that realizes a reliability calculation apparatus 2 according to an embodiment of the present invention.

FIG. 4 is a diagram showing an example of document-evaluator information used in an embodiment example of the present invention.

FIG. 5 is a diagram showing an example of document-author information used in an embodiment example of the present invention.

FIG. 6 is a diagram showing an example of a conventional information evaluation apparatus.

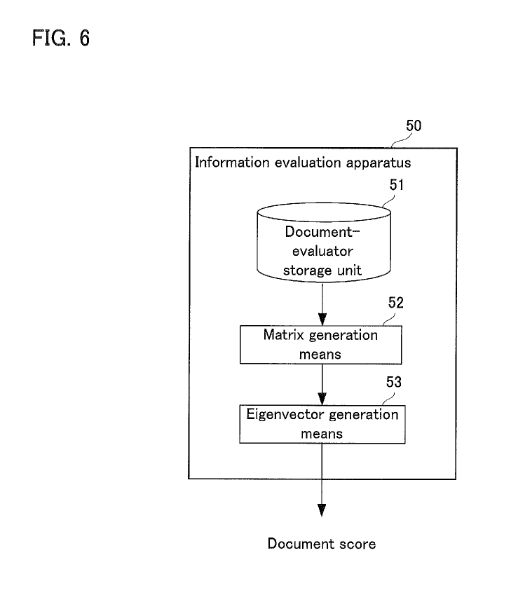

### DESCRIPTION OF EMBODIMENTS

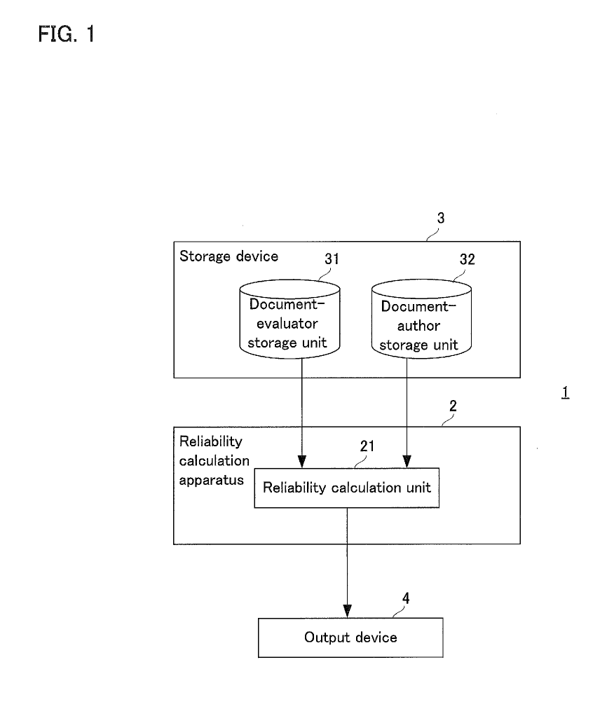

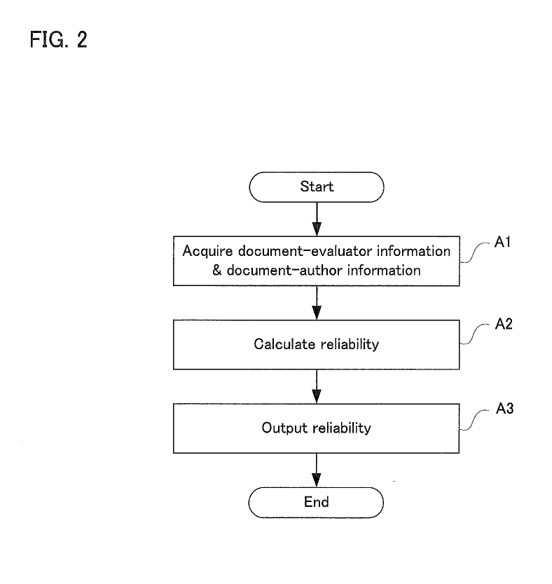

Hereinafter, a reliability calculation apparatus, a calculation method and a program according to an embodiment of the present invention will be described, with reference to FIGS. 1 and 2.

Device Configuration

Initially, a configuration of the reliability calculation apparatus according to the present embodiment will be described using FIG. 1. FIG. 1 is a block diagram showing the configuration of the reliability calculation apparatus according to the embodiment of the present embodiment.

A reliability calculation apparatus 2 according to the present embodiment shown in FIG. 1 is an apparatus for calculating a reliability that serves as an index of reliableness of an evaluator who evaluated a document. Reliabilities calculated by the reliability computing apparatus 2 are, for example, used for ranking documents in a search system (not shown in FIG. 1).

Also, as shown in FIG. 1, the reliability calculation apparatus 2 is provided with a reliability calculation unit 21. The reliability calculation unit 21 first acquires information (hereinafter, “document-evaluator information”) specifying respective correspondence relationships between documents targeted for evaluation (documents evaluated in the past), evaluators who evaluated the documents and contents of the evaluations. The reliability calculation unit 21 also acquires information (hereinafter, “document-author information”) specifying respective correspondence relationships between the documents and authors of the documents.

The reliability calculation unit 21 then specifies, the extent of evaluations for each evaluator with respect to each author, based on the document-evaluator information and the document-author information, and calculates, for each evaluator, the reliability of the evaluator, based on the specified extent of evaluations with respect to each author.

In this way, with the reliability calculation apparatus 2, evaluations of a document given by each evaluator are linked to the author of the document, and the reliability of each evaluator is calculated from the evaluations for each author rather than for each document. Therefore, even in the case where there are few evaluations of each document, it becomes possible to avoid a situation where the reliability cannot be calculated correctly due to there being a limited amount of evaluation data, since the same author may have written a plurality of documents. According to the reliability calculation apparatus 2, the reliability of an evaluator can be correctly calculated, even if there is a limited amount of evaluation data, unlike the conventional technology.

Here, the configuration of the reliability calculation apparatus 2 will be described more specifically. First, in the present embodiment, as shown in FIG. 1, the reliability calculation apparatus 2 structures a user reliability calculation system 1 together with a storage device 3 storing various information and an output device 4 such as a display device. As will be discussed later, in the present embodiment, the reliability calculation apparatus 2 is structured by a computer that operates by program control.

The storage device 3 is provided with a document-evaluator storage unit 31 and a document-author storage unit 32. Of these, the document-evaluator storage unit 31 stores the abovementioned document-evaluator information. The document-author storage unit 32 stores the abovementioned document-author information.

Also, as mentioned above, the document-evaluator information specifies respective correspondence relationships between documents targeted for evaluation (documents evaluated in the past), evaluators who evaluated the documents, and contents of the evaluations, with specific examples of the contents of evaluations including the following.

For example, assume that a search system displays a screen allowing the user to select either “helpful” or “not helpful”, in order to prompt the user to evaluate a document extracted in a search. In this case, the document-evaluator storage unit 31, on the user having made a selection, records an ID of the user (evaluator) who is logged in, an ID of the document that is targeted for evaluation (document currently being displayed), and the selected evaluation (“helpful” or “not helpful”) as group data. This recorded group data serves as document-evaluator information.

Also, in the present embodiment, the reliability calculation unit 21 creates a matrix in which rows indicate evaluators and columns indicate authors, and is thereby able to specify the evaluations for each evaluator with respect to each author mentioned above. At this time, exemplary elements of the matrix include the following three types.

The first is the number of times that a specific evaluation is assigned by each evaluator to documents of each author. The second is a sum of the evaluation values for each author in the case where evaluation values are assigned by each evaluator to the documents. The third is a percentage for each author of documents assigned a specific evaluation by each evaluator. These will be discussed later. Note that using a matrix thus facilitates specification of the evaluations for each evaluator with respect to each author.

Also, in the present embodiment, the contents of evaluations may be set in stages, such as “good” and “better”, or “good” and “bad”. In this case, the reliability calculation unit 21 is able to calculate, for each stage, the reliability by creating a matrix with the stage as the abovementioned “specific evaluation”, and thereafter combining, for each evaluator, the reliabilities calculated for each stage and taking the resultant value as the final reliability of the evaluator.

Furthermore, in the present embodiment, the reliability calculation unit 21 is also able to calculate, for each author of a document, an author reliability showing the degree to which the author has been evaluated by each evaluator, using the created matrix and the reliability of each evaluator.

In the case of calculating the author reliability, the reliability calculation unit 21 is also able to compute, for each document targeted for evaluation, a document score showing the degree to which the document has been evaluated by each evaluator, using the contents of the evaluations for the document and the author reliability for the author of the document.

With regard to the search results of a search system, when such author reliabilities and document scores are output together with the search results, the user is able to utilize the search results more effectively.

In addition, in the present embodiment, the reliability calculation unit 21 is also able to calculate the reliability of each evaluator for a given user, and is further able to calculate the reliability of each author for a given user. Also, in this case, the reliability calculation unit 21 is also able to derive the similarity between the user and each evaluator for a document, and to compute a document score showing the degree to which the user has evaluated the document.

### Operations

Next, operations of the reliability calculation apparatus 2 according to the embodiment of the present invention will be described using FIG. 2. FIG. 2 is a flowchart showing operations of the reliability calculation apparatus according to the embodiment of the present invention. In the following description, FIG. 1 will be referred to as appropriate. Also, in the present embodiment, the reliability calculation method is implemented by operating the reliability calculation apparatus 2. Therefore, description of the reliability calculation method according to the present embodiment is replaced by the following description of the operations of the reliability calculation apparatus 2.

As shown in FIG. 2, initially, in the reliability calculation apparatus 2, the reliability calculation unit 21 accesses the document-evaluator storage unit 31 and acquires document-evaluator information, and further accesses the document-author storage unit 32 and acquires document-author information (step A1).

Next, the reliability calculation apparatus 2 generates a matrix A (discussed later) using the document-evaluator information and the document-author information acquired at step A1, and calculates the reliability for each evaluator using the matrix A (step A2). The matrix A is a matrix in which rows indicate evaluators and columns indicate authors. In the present embodiment, the reliability calculation unit 2, in step A2, also calculates the author reliability.

Thereafter, the reliability calculation apparatus 2 outputs the calculated reliability to the output device 4 (step A3). The reliability calculation apparatus 2 is also able to output the calculated reliability to a search system. In this case, the reliability will be reflected in the search results of the search system.

### Specific Example 1

Here, step A2 will be described in detail. The following specific example 1 is an example in which “good” is the only evaluation contents included in the document-evaluator information. The evaluation “good” is assigned in stages such as “good” and “very good”, for example. Also, in each stage, the evaluation value is set to increases the better the evaluation.

Specifically, it is assumed that positive values are set as evaluation values, such as 1 for “good” and 2 for “very good”. Also, in the specific example 1, numbers 1 to N are assigned to the evaluators and the authors, and natural numbers i and j that are used hereinafter satisfy 1≦i≦N and 1≦j≦N. Note that although the number of evaluators and the number of authors are both N in the following example, the present embodiment is not limited thereto, and the number of evaluators need not match the number of authors.

In the matrix A generated by the reliability calculation unit 21, exemplary elements of the ith row and the jth column include “number of times ith evaluator evaluated documents of jth author” or “sum of evaluation values in case where ith evaluator evaluated documents of jth author”.

A further exemplary element of the ith row and the jth column includes “percentage for jth author of documents assigned specific evaluation by ith evaluator” (=number of documents written by jth author among documents assigned specific evaluation by ith evaluator/documents assigned specific evaluation by ith evaluator). This element is, in other words, a percentage showing which authors have been evaluated by an evaluator, and this percentage can also be acquired by normalizing the row vector.

Alternatively, the element of the ith row and the jth column may be a percentage of the evaluations by the ith evaluator among the evaluations of all evaluators with respect to documents written by the jth author. This percentage can also be acquired by normalizing the column vector. For example, assume that, with regard to documents written by the jth author, all evaluators have given an evaluation, with the total evaluation value being X and the evaluation value of the evaluation of the ith evaluator being Y. In this case, the element of the ith row and the jth column will be “Y/X”.

Furthermore, in the present embodiment, in order to avoid the evaluation values of documents that have not been evaluated by an evaluator all being 0, the reliability calculation unit 21 is also able to add a positive constant to all elements of the matrix A.

The reliability calculation unit 21 then derives the reliabilities of the evaluators (evaluator reliabilities s) and the reliabilities of the authors (author reliabilities t), using the resultant matrix A. Specifically, the reliability calculation unit 21 calculates the evaluator reliability s and the author reliability t as the solutions of the following equations 1 and 2. Also, in the following equation 1, “X” is a positive constant. In the following equation 2, “v” is a positive constant.

$$\begin{matrix}{t}_{i} = λ {\sum }_{j}^{ } {A}_{ji} {s}_{j} & Equation 1 \\ {s}_{i} = v {\sum }_{j}^{ } {A}_{ij} {t}_{j} & Equation 2\end{matrix}$$

In order to obtain the solutions of the above equations 1 and 2, the reliability calculation unit 21 derives the evaluator reliability s as an eigenvector of AA^{T}, where A^{T} is the transposed matrix of A, for example. Also, the reliability calculation unit 21 derives the author reliability t using the above equation 1.

### Specific Example 2

Next, a specific example 2 will be described. The following specific example 2 is an example in which the two stages “good” and “bad” are the evaluation contents included in the document-evaluator information. Also, in the specific example 2, the reliability calculation unit 21 creates a matrix A⁺ and a matrix A⁻.

Of these, in the matrix A⁺, exemplary elements of the ith row and the jth column include “number of times ith evaluator evaluated documents of jth author as ‘good’” or “sum of evaluation values in case where ith evaluator evaluated documents of jth author as ‘good’”.

Also, in the matrix A⁻, exemplary elements of the ith row and the jth column include “number of times ith evaluator evaluated documents of jth author as ‘bad’” or “sum of evaluation values (absolute values) in case where ith evaluator evaluated documents of jth author as ‘bad’”.

The reliability calculation unit 21 then calculates the evaluator reliability s and the author reliability t for each evaluation stage, using the matrix A⁺ and the matrix A⁻. In the case where reliability is calculated for each stage, evaluators who have the same evaluation tendency can thus be specified, and it becomes possible to reflect this in search results.

Specifically, the reliability calculation unit 21 takes s⁺ as the evaluator reliability in the case where the evaluation is “good” and t⁺ as the author reliability likewise in the case where the evaluation is “good”, and calculates these reliabilities as the solutions of the following equations 3 and 4. Also, in the following equation 3, “λ⁺” is a positive constant. In the following equation 2, “v⁺” is a positive constant.

$$\begin{matrix}{t}_{i}^{t} = {λ}^{+} {\sum }_{j}^{ } {A}_{ji}^{+} {s}_{j}^{+} & Equation 3 \\ {s}_{i}^{+} = {v}^{+} {\sum }_{j}^{ } {A}_{ij}^{+} {t}_{j}^{+} & Equation 4\end{matrix}$$

Also, the reliability calculation unit 21 takes s⁻ as the evaluator reliability in the case where the evaluation is “bad” and t⁻ as the author reliability likewise in the case where the evaluation is “bad”, and calculates these reliabilities as the solutions of the following equations 5 and 6. Also, in the following equation 5, “λ⁻” is a positive constant. In the following equation 6, v⁻” is a positive constant.

$$\begin{matrix}{t}_{i}^{-} = {λ}^{-} {\sum }_{j}^{ } {A}_{ji}^{-} {s}_{j}^{-} & Equation 5 \\ {s}_{i}^{-} = {v}^{-} {\sum }_{j}^{ } {A}_{ij}^{-} {t}_{j}^{-} & Equation 6\end{matrix}$$

Thereafter, the reliability calculation unit 21 applies s⁺, t⁺, s⁻ and t⁻ obtained by equations 3 to 6 to the following equations 7 and 8 to calculate the final evaluator reliability s and the final author reliability t. Also, in the case where the specific example 2 is executed, the reliability calculation unit 21, in step A3, is able to output the reliabilities during calculation, that is, s⁺, t⁺, s⁻, and t⁻, in addition to the final evaluator reliability s and the final author reliability t.

s=s⁺+s⁻ Equation 7

t=t⁺+t⁻ Equation 8

### Specific Example 3

Next, a specific example 3 will be described. In the specific example 3, the reliability calculation unit 21, after deriving the evaluator reliability s and the author reliability t according to the specific example 1 or the specific example 2, computes a document score for each document, using the contents of the evaluation with respect to the document and the author reliability of the author of the document. Here, the document score of a document d is given as “w_{d}”.

Specifically, the reliability calculation unit 21 acquires an evaluation value B_{jd} assigned by the evaluator j to the document d from the document-evaluator storage unit 31, as the contents of the evaluation corresponding to the document. The reliability calculation unit 21 then applies the acquired evaluation value B_{jd}, the evaluator reliability s and the author reliability t to the following equation 9 to calculate the document score w_{d} of the document d. Note that, in the following equation 9, C_{dj} is a parameter that is set to “1” if the user j is the author of the document d and to “0” if the user j is not the author of the document d.

$${w}_{d} = {\sum }_{j}^{ } {s}_{j} {B}_{jd} + {\sum }_{j}^{ } {t}_{j} {C}_{dj} \qquad Equation 9$$

### Specific Example 4

Next, a specific example 4 will be described. In the specific example 4, the reliability calculation unit 21 generates the matrix A based on the document-evaluator information stored in the document-evaluator storage unit 31, similarly to the specific example 1 or the specific example 2, and calculates the reliability of the evaluator j for a specific user (evaluator i) using the generated matrix A.

Specifically, the reliability calculation unit 21 applies the generated matrix A to the following equations 10 and 11 to derive the reliability of the evaluator j for the evaluator i (evaluator reliability sᵢⱼ), and the reliability of the author j for the evaluator (author reliability tᵢⱼ). Note that, in the following equations 10 and 11, k is a natural number from 1 to N. Note also that, as described in the specific example 1, N is the number of evaluators and authors, and the natural numbers i and j satisfy 1≦i≦N and 1≦j≦N.

$$\begin{matrix}{s}_{ij} = {\sum }_{k}^{ } {A}_{jk} {t}_{ik} & Equation 10 \\ {t}_{ij} = {\sum }_{k}^{ } {A}_{kj} {s}_{ik} & Equation 11\end{matrix}$$

Also, in the specific example 4, the reliability calculation unit 21 is further able to calculate the document score for each evaluator, using the evaluator reliability sᵢⱼ and the author reliability tᵢⱼ. A document score w_{kd} in this case shows the degree to which a given evaluator k has evaluated the document d. Specifically, the reliability calculation unit 21 calculates the document score w_{kd} using following equation 12. In the following equation 12, vₖᵢ is the similarity between the evaluator k and the evaluator j. The document score w_{kd} will take a higher value as the similarity vₖᵢ increases.

Note that the similarity vₖᵢ is decided based on the similarity between documents targeted for evaluation, the similarity between documents created by each evaluator, the length of time for which each evaluator has been active, or the like. For example, the cosine similarity between the sum of word vectors of documents evaluated by the evaluator i and the sum of word vectors of documents evaluated by the evaluator j can be used as the similarity via. Also, in the following equation 12, B_{jd} and C_{dj} are similar to equation 9.

$${w}_{kd} = {\sum }_{i}^{ } {v}_{kl} ( {\sum }_{j}^{ } {s}_{ij} {B}_{jd} + {\sum }_{j}^{ } {t}_{ij} {C}_{dj} ) \qquad Equation 12$$

### Effects of Embodiment

As described above, according to the present embodiment, it becomes possible to more appropriately judge the reliability of an evaluator using a limited amount of evaluation data.

Reason: In other words, in the case of calculating the reliability for each target document, the number of targets for measuring evaluation frequencies tends to be large, and individual frequencies tend to be low. In contrast, in the case of calculating the reliability for each author, since the same writer may have written a plurality of documents, the number of targets for measuring evaluation frequencies tends to be smaller, and individual frequencies tend to be higher. In other words, the number of patterns is fewer in the case of determining whether documents by the same author have been evaluated than in the case of determining whether the same document has been evaluated.

### Program of Embodiment

A program according to the embodiment of the present invention need only be a program that causes a computer to execute steps A1 to A3 shown in FIG. 2. The reliability calculation apparatus and the reliability calculation method according to the present embodiment can be realized by installing this program on a computer and executing the installed program. In this case, a CPU (Central Processing Unit) of the computer functions as the reliability calculation unit 21 and performs processing.

Also, in this case, the storage device 3 may be a storage device such as a hard disk provided in the computer on which the program is installed, or may be a storage device provided in another computer connected by a network.

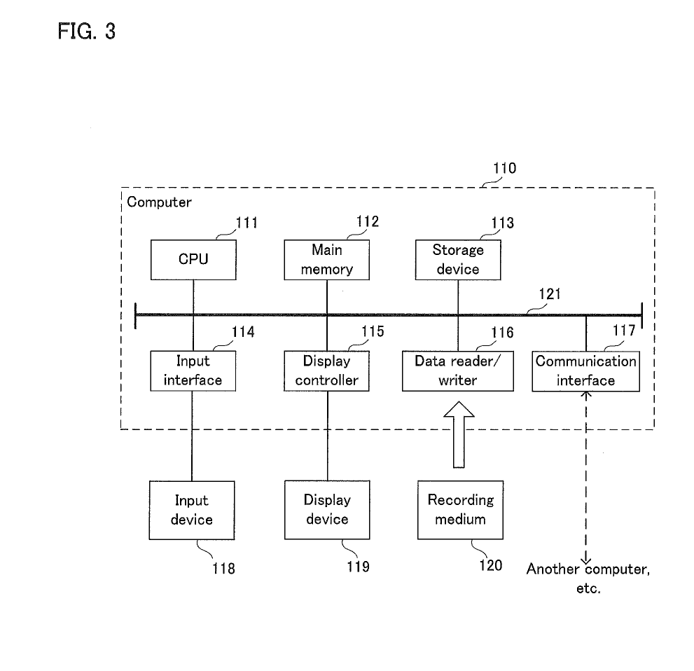

Here, a computer that realizes the reliability calculation apparatus 2 by executing a program according to the embodiment will be described using FIG. 3. FIG. 3 is a block diagram showing an example of a computer that realizes the reliability calculation apparatus 2 according to the embodiment of the present invention.

As shown in FIG. 3, a computer 110 is provided with a CPU 111, a main memory 112, a storage device 113, an input interface 114, a display controller 115, a data reader/writer 116, and a communication interface 117. These units are connected to each other so as to enable data transmission via a bus 121.

The CPU 111 implements various types of arithmetic operations by expanding programs (codes) according to the present embodiment stored in the storage device 113 in the main memory 112, and executing these programs (codes) in a predetermined order. The main memory 112, typically, is a volatile storage device such as DRAM (Dynamic Random Access Memory). Also, a program according to the present embodiment is provided in a state of being stored on a computer-readable recording medium 120. Note that a program according to the present embodiment may be distributed over the Internet connected via the communication interface 117.

Also, specific examples of the storage device 113 include a semiconductor memory device such as a flash memory, apart from a hard disk. The input interface 114 mediates data transmission between the CPU 111 and an input device 118 consisting of a keyboard and a mouse. The display controller 115 is connected to a display device 119 and controls display on the display device 119. A data reader/writer 116 mediates data transmission between the CPU 111 and the recording medium 120, and executes reading out of programs from the recording medium 120 and writing of processing results of the computer 110 to the recording medium 120. The communication interface 117 mediates data transmission between the CPU 111 and another computer.

Also, specific examples of the recording medium 120 include a general-purpose semiconductor memory device such as CF (Compact Flash (registered trademark)) and SD (Secure Digital), a magnetic storage medium such as a flexible disk, and an optical storage medium such as CD-ROM (Compact Disk Read Only Memory).

### Embodiment Example

Next, operations of the reliability calculation apparatus 2 according to the present embodiment will be described using a specific embodiment example 1. Also, the following will be described in line with the steps shown in FIG. 2. Note that FIGS. 1 and 2 will be referred to as appropriate.

### Preconditions

First, as preconditions of the embodiment example 1, it is assumed that there are users 1, 2 and 3 who are both evaluators and writers and documents 1, 2, 3, 4 and 5. Also, it is assumed that the user 1 evaluates the document 5 as an evaluator 1, the user 2 evaluates the documents 1 and 4 as an evaluator 2, and the user 3 evaluates the document 3 as an evaluator 3. Furthermore, it is assumed that the user 1 is an author 1 of the documents 1 and 2, the user 2 is an author 2 of the document 3, and the user 3 is an author 3 of the documents 4 and 5.

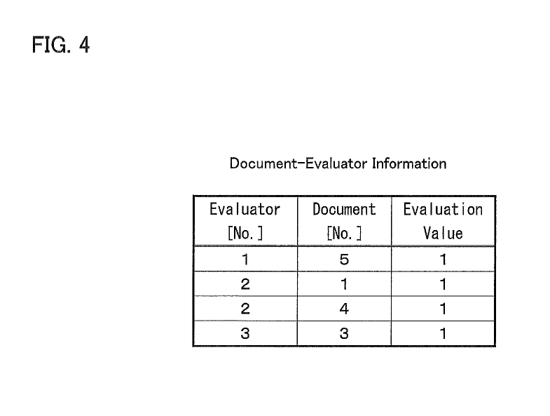

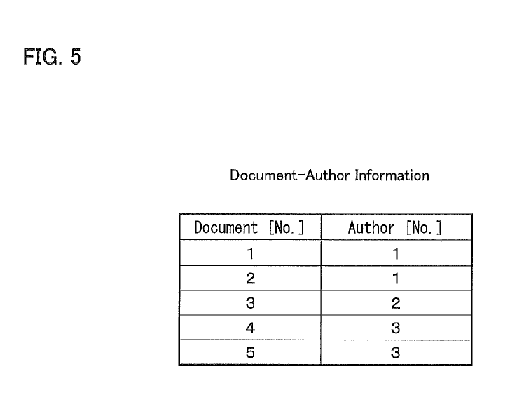

With regard to the above preconditions, the document-evaluator storage unit 31 stores the data shown in FIG. 4 as document-evaluator information. Also, the document-author storage unit 32 stores the data shown in FIG. 5 as document-author information. FIG. 4 is a diagram showing an example of document-evaluator information used in the embodiment example of the present invention. FIG. 5 is a diagram showing an example of document-author information used in the embodiment example of the present invention.

### Step A1

First, in the reliability calculation apparatus 2, the reliability calculation unit 21 acquires the document-evaluator information shown in FIG. 4 from the document-evaluator storage unit 31, and further acquires the document-author information shown in FIG. 5 from the document-author storage unit 32.

### Step A2

Next, the reliability calculation unit 21 generates the matrix A using the document-evaluator information and the document-author information acquired at step A1. In this embodiment example, the matrix A will be as shown in the following equation 13. Also, in the following equation 13, percentages for each author of documents assigned a specific evaluation by each evaluator are used as the elements of the matrix, with these percentages being obtained by normalizing the row vectors.

$$A = ( \begin{matrix}0 & 0 & 1 \\ 1 \text{/} 2 & 0 & 1 \text{/} 2 \\ 0 & 1 & 0\end{matrix} ) \qquad Equation 13$$

Next, the reliability calculation unit 21, in order to specify the evaluations for each evaluator with respect to each author, applies the matrix A shown in equation 13 to the abovementioned equations 1 and 2 to derive the equation shown in the following equation 14. The reliability calculation unit 21 then derives the solution of the equation shown in the following equation 14. At this time, there are a plurality of eigenvectors that give a solution, but the reliability calculation unit 21 selects the eigenvector corresponding to the largest eigenvalue, for example. The solution is as shown in the following equation 15.

$$\begin{matrix}( \begin{matrix}{s}_{1} \\ {s}_{2} \\ {s}_{3}\end{matrix} ) = λ ( \begin{matrix}0 & 0 & 1 \\ 1 \text{/} 2 & 0 & 1 \text{/} 2 \\ 0 & 1 & 0\end{matrix} ) ( \begin{matrix}0 & 1 \text{/} 2 & 0 \\ 0 & 0 & 1 \\ 0 & 1 \text{/} 2 & 0\end{matrix} ) ( \begin{matrix}{s}_{1} \\ {s}_{2} \\ {s}_{3}\end{matrix} ) & Equation 14 \\ ( \begin{matrix}{s}_{1} \\ {s}_{2} \\ {s}_{3}\end{matrix} ) = ( \begin{matrix}0.8507 \\ 0.5257 \\ 0.0000\end{matrix} ) & Equation 15\end{matrix}$$

The reliability calculation unit 21 also calculates the author reliabilities t by applying the values of equation 15 and the matrix A shown in equation 13 to equation 1. The values of the author reliabilities t will be as shown in the following equation 16.

$$( \begin{matrix}{t}_{1} \\ {t}_{2} \\ {t}_{3}\end{matrix} ) = ( \begin{matrix}0.8507 \\ 0.0000 \\ 1.3764\end{matrix} ) \qquad Equation 16$$

Once all calculations have ended, the reliability calculation unit 21 outputs the evaluator reliabilities s and the author reliabilities t thus calculated to the output device 4. The output device 4 displays the values shown in equation 15 and the values shown in equation 16 on a display screen, for example. Also, the displayed values are used for ranking documents in a search system or the like.

While part or all of the abovementioned embodiment and embodiment example can be realized by Notes 1 to 15 described below, the present invention is not limited to the following description.

### Note 1

A reliability calculation apparatus for calculating a reliability that serves as an index of reliableness of an evaluator who evaluated a document includes a reliability calculation unit that specifies an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculates the reliability of each evaluator, based on the specified evaluation with respect to each author.

### Note 2

In the reliability calculation apparatus according to note 1, the reliability calculation unit specifies the evaluation with respect to each author, by creating a matrix in which rows indicate evaluators, columns indicate authors, and elements are one of a number of times that a specific evaluation is assigned by each evaluator to documents of each author, a sum of evaluation values for each author in a case where evaluation values are assigned by each evaluator to the documents, a percentage for each author relative to all authors of documents assigned a specific evaluation by each evaluator, and a percentage of evaluations by each evaluator among evaluations by all evaluators with respect to documents written by each author.

### Note 3

In the reliability calculation apparatus according to note 2, the contents of the evaluations are set in stages, and the reliability calculation unit calculates, for each stage, the reliability by creating the matrix with the stage as the specific evaluation, and thereafter combines, for each evaluator, the reliabilities calculated for each stage and takes the resultant value as a final reliability of the evaluator.

### Note 4

In the reliability calculation apparatus according to note 2 or 3, the reliability calculation unit calculates, for each author, an author reliability indicating a degree to which the author has been evaluated by each evaluator, using the matrix and the reliability of each evaluator.

### Note 5

In the reliability calculation apparatus according to note 4, the reliability calculation unit computes, for each document targeted for evaluation, a document score indicating a degree to which the document has been evaluated by each evaluator, using the contents of the evaluations on the document and the author reliability of the author of the document.

### Note 6

A reliability calculation method for calculating a reliability that serves as an index of reliableness of an evaluator who evaluated a document, includes the step of (a) specifying an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculating the reliability of each evaluator, based on the specified evaluation with respect to each author.

### Note 7

In the reliability calculation method according to note 6, in the step (a) the evaluation with respect to each author is specified by creating a matrix in which rows indicate evaluators, columns indicate authors, and elements are one of a number of times that a specific evaluation is assigned by each evaluator to documents of each author, a sum of evaluation values for each author in a case where evaluation values are assigned by each evaluator to the documents, a percentage for each author relative to all authors of documents assigned a specific evaluation by each evaluator, and a percentage of evaluations by each evaluator among evaluations by all evaluators with respect to documents written by each author.

### Note 8

In the reliability calculation method according to note 7, the contents of the evaluations are set in stages, and in the step (a) the reliability is calculated for each stage by creating the matrix with the stage as the specific evaluation, and thereafter the reliabilities calculated for each stage are combined for each evaluator and the resultant value is taken as a final reliability of the evaluator.

### Note 9

The reliability calculation method according to note 7 or 8 further includes the step of (b) calculating, for each author, an author reliability indicating a degree to which the author has been evaluated by each evaluator, using the matrix and the reliability of each evaluator.

### Note 10

The reliability calculation method according to note 9 further includes the step of (c) computing, for each document targeted for evaluation, a document score indicating a degree to which the document has been evaluated by each evaluator, using the contents of the evaluations on the document and the author reliability of the author of the document.

### Note 11

A computer-readable recording medium storing a program for calculating by computer a reliability that serves as an index of reliableness of an evaluator who evaluated a document, the program including a command for causing the computer to execute the step of (a) specifying an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculating the reliability of each evaluator, based on the specified evaluation with respect to each author.

Note 12

In the computer-readable recording medium according to note 11, in the step (a) the evaluation with respect to each author is specified by creating a matrix in which rows indicate evaluators, columns indicate authors, and elements are one of a number of times that a specific evaluation is assigned by each evaluator to documents of each author, a sum of evaluation values for each author in a case where evaluation values are assigned by each evaluator to the documents, a percentage for each author relative to all authors of documents assigned a specific evaluation by each evaluator, and a percentage of evaluations by each evaluator among evaluations by all evaluators with respect to documents written by each author.

### Note 13

In the computer-readable recording medium according to note 12, the contents of the evaluations are set in stages, and in the step (a) the reliability is calculated for each stage by creating the matrix with the stage as the specific evaluation, and thereafter the reliabilities calculated for each stage are combined for each evaluator and the resultant value is taken as a final reliability of the evaluator.

### Note 14

In the computer-readable recording medium according to note 12 or 13, the program further includes a command for causing the computer to further execute the step of (b) calculating, for each author, an author reliability indicating a degree to which the author has been evaluated by each evaluator, using the matrix and the reliability of each evaluator.

### Note 15

In the computer-readable recording medium according to note 14, the program further includes a command for causing the computer to further execute the step of (c) computing, for each document targeted for evaluation, a document score indicating a degree to which the document has been evaluated by each evaluator, using the contents of the evaluations on the document and the author reliability of the author of the document.

Although the claimed invention was described above with reference to an embodiment and an embodiment example, the claimed invention is not limited to the above embodiment and embodiment example. Those skilled in the art will appreciate that various modifications can be made to the configurations and details of the claimed invention without departing from the scope of the claimed invention.

This application is based upon and claims the benefit of priority of the prior Japanese Patent Application No. 2012-4399, filed on Jan. 12, 2012, the entire contents of which are incorporated herein by reference.

### INDUSTRIAL APPLICABILITY

The present invention can be applied to applications such as a search system that presents documents evaluated by reliable evaluators at a high ranking, on the basis of the evaluations of users.

### DESCRIPTION OF REFERENCE NUMERALS

1 User Reliability Calculation System
2 Reliability Calculation Apparatus
3 Storage Device
4 Output Device
21 Reliability Calculation Unit
31 Document-Evaluator Storage Unit
32 Document-Author Storage Unit
110 Computer
111 CPU
112 Main Memory
113 Memory Storage
114 Input Interface
115 Display Controller
116 Data Reader/Writer
117 Communication Interface
118 Input Device
119 Display Device
120 Recording Medium
121 Bus

1. A reliability calculation apparatus for calculating a reliability that serves as an index of reliableness of an evaluator who evaluated a document, comprising:
a reliability calculation unit that specifies an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculates the reliability of each evaluator, based on the specified evaluation with respect to each author.

2. The reliability calculation apparatus according to claim 1, wherein the reliability calculation unit specifies the evaluation with respect to each author, by creating a matrix in which rows indicate evaluators, columns indicate authors, and elements are one of a number of times that a specific evaluation is assigned by each evaluator to documents of each author, a sum of evaluation values for each author in a case where evaluation values are assigned by each evaluator to the documents, a percentage for each author relative to all authors of documents assigned a specific evaluation by each evaluator, and a percentage of evaluations by each evaluator among evaluations by all evaluators with respect to documents written by each author.

3. The reliability calculation apparatus according to claim 2,
wherein the contents of the evaluations are set in stages, and
the reliability calculation unit calculates, for each stage, the reliability by creating the matrix with the stage as the specific evaluation, and thereafter combines, for each evaluator, the reliabilities calculated for each stage and takes the resultant value as a final reliability of the evaluator.

4. The reliability calculation apparatus according to claim 2,
wherein the reliability calculation unit calculates, for each author, an author reliability indicating a degree to which the author has been evaluated by each evaluator, using the matrix and the reliability of each evaluator.

5. The reliability calculation apparatus according to claim 4,
wherein the reliability calculation unit computes, for each document targeted for evaluation, a document score indicating a degree to which the document has been evaluated by each evaluator, using the contents of the evaluations on the document and the author reliability of the author of the document.

6. A reliability calculation method for calculating a reliability that serves as an index of reliableness of an evaluator who evaluated a document, comprising the step of:
(a) specifying an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculating the reliability of each evaluator, based on the specified evaluation with respect to each author.

7. A computer-readable recording medium storing a program for calculating by computer a reliability that serves as an index of reliableness of an evaluator who evaluated a document, the program including a command for causing the computer to execute the step of:
(a) specifying an evaluation by each evaluator with respect to each author, based on first information specifying respective correspondence relationships between documents targeted for evaluation, evaluators who evaluated the documents and contents of the evaluations, and second information specifying respective correspondence relationships between the documents and authors of the documents, and calculating the reliability of each evaluator, based on the specified evaluation with respect to each author.

8. The reliability calculation method according to claim 6,
in the step (a) the evaluation with respect to each author is specified by creating a matrix in which rows indicate evaluators, columns indicate authors, and elements are one of a number of times that a specific evaluation is assigned by each evaluator to documents of each author, a sum of evaluation values for each author in a case where evaluation values are assigned by each evaluator to the documents, a percentage for each author relative to all authors of documents assigned a specific evaluation by each evaluator, and a percentage of evaluations by each evaluator among evaluations by all evaluators with respect to documents written by each author.

9. The reliability calculation method according to claim 8, wherein the contents of the evaluations are set in stages, and
in the step (a) the reliability is calculated for each stage by creating the matrix with the stage as the specific evaluation, and thereafter the reliabilities calculated for each stage are combined for each evaluator and the resultant value is taken as a final reliability of the evaluator.

10. The reliability calculation method according to claim 8,
wherein further includes the step of (b) calculating, for each author, an author reliability indicating a degree to which the author has been evaluated by each evaluator, using the matrix and the reliability of each evaluator.

11. The reliability calculation method according to claim 10,
wherein further includes the step of (c) computing, for each document targeted for evaluation, a document score indicating a degree to which the document has been evaluated by each evaluator, using the contents of the evaluations on the document and the author reliability of the author of the document.

12. The computer-readable recording medium according to claim 7,
in the step (a) the evaluation with respect to each author is specified by creating a matrix in which rows indicate evaluators, columns indicate authors, and elements are one of a number of times that a specific evaluation is assigned by each evaluator to documents of each author, a sum of evaluation values for each author in a case where evaluation values are assigned by each evaluator to the documents, a percentage for each author relative to all authors of documents assigned a specific evaluation by each evaluator, and a percentage of evaluations by each evaluator among evaluations by all evaluators with respect to documents written by each author.

13. The computer-readable recording medium according to claim 12,
wherein the contents of the evaluations are set in stages, and
in the step (a) the reliability is calculated for each stage by creating the matrix with the stage as the specific evaluation, and thereafter the reliabilities calculated for each stage are combined for each evaluator and the resultant value is taken as a final reliability of the evaluator.

14. The computer-readable recording medium according to claim 12,
wherein the program further includes a command for causing the computer to further execute the step of (b) calculating, for each author, an author reliability indicating a degree to which the author has been evaluated by each evaluator, using the matrix and the reliability of each evaluator.

15. The computer-readable recording medium according to claim 14,
Wherein the program further includes a command for causing the computer to further execute the step of (c) computing, for each document targeted for evaluation, a document score indicating a degree to which the document has been evaluated by each evaluator, using the contents of the evaluations on the document and the author reliability of the author of the document.
